(19) United States
(12) Patent Application Publication
(10) Pub. No.: US 2009/0083802 A1
(43) Pub. Date: Mar. 26, 2009

(54) Broadcast Receiving Apparatus

(75) Inventors: Atsushi Kohno, Tokyo (JP); Reiko Okada, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORAtion, Tokyo (JP)

(21) Appl. No.: 11/988,236

(22) PCT Filed: May 24, 2006
(86) PCT No.: PCT/JP2006/310381

§ 371 Date: Jan. 3, 2008

(30) Foreign Application Priority Data
Sep. 28, 2005 (JP) 2005-282500

(51) Int. Cl. H04N 5/445; H04N 7/173

(52) U.S. Cl. 725/59; 725/38; 725/134

(57) ABSTRACT

A broadcast receiving apparatus includes a broadcast receiving section 11 for receiving a broadcast, an expansion service providing section 12 for providing an expansion service, an expansion service decision section 13 for making a valid/invalid decision about the expansion service, a channel alteration section 14 for adding the expansion service as one channel when it is decided as valid, an input section 15 for selecting one channel from channels receivable by the broadcast receiving section and from channels added, a channel control section 16 for starting, when the selected channel is a channel receivable by the broadcast receiving section, reception of the broadcast on the channel and for switching between the broadcast receiving section and the expansion service providing section to select one of their outputs, and an output section 17-20 for outputting information based on the output of the broadcast receiving section or the expansion service providing section switched.

### TECHNICAL FIELD

The present invention relates to a broadcast receiving apparatus for receiving broadcasting, and more particularly to a technique for selecting an expansion service offered as an added function to a broadcast receiving function.

### BACKGROUND ART

An increasing number of recent television broadcast receivers have, besides the basic function of receiving and displaying a television broadcast, added functions such as providing a user with home page information by connecting to the Internet and by accessing to a WWW (World Wide Web) site. In particular, with the start of the digital terrestrial broadcasting, television broadcast receivers incorporate more and more functions, which brings about a noticeable tendency to desire added functions.

However, when a user selects an added function on a television broadcast receiver, a remote controller (referred to as a “remote control” from now on) or a menu on a screen must have a button or item for selecting the added function. Thus, every time an added function is attached, it is necessary to prepare a new remote control or a new menu on a screen. This offers a problem of involving a cost increase of the television broadcast receiver itself with the added functions.

To solve the foregoing problem, an apparatus has been developed which enables a user to read WWW site information in response to a channel operation, the basic operation of the television broadcast receiver. For example, Patent Document 1 discloses a Web program read apparatus that implements unification and simplification of the operation by enabling the user to handle the Web document in the same manner as television programs through the operation corresponding to the ordinary channel operation of the television broadcast receiver.

Patent Document 1: Japanese Patent Laid-open No. 2000-231528.

However, even if the access to the Internet is impossible because of cable severance or a fault of a service provider, or a home page cannot be read because of a server failure on the WWW site side, the conventional Web program read apparatus disclosed in the Patent Document 1 has a problem of displaying an abnormal picture as a Web program when the channel operation is performed.

The present invention is implemented to solve the foregoing problem. Therefore it is an object of the present invention to provide a broadcast receiving apparatus capable of offering a user only valid expansion services among the expansion services provided as added functions through the channel operation.

### DISCLOSURE OF THE INVENTION

The broadcast receiving apparatus in accordance with the present invention includes: a broadcast receiving section for receiving a broadcast through a channel designated by channel control information; an expansion service providing section for providing an expansion service as an added function to a broadcast receiving function; an expansion service decision section for making a decision as to whether the expansion service provided by the expansion service providing section is valid or not; a channel alteration section for adding, when the expansion service decision section makes a decision that the expansion service is valid, the expansion service provided by the expansion service providing section as one channel; an input section for inputting operation information for selecting one channel from channels receivable by the broadcast receiving section and a channel added by the channel alteration section; a channel control section for starting, when the channel selected according to the operation information input from the input section is a channel receivable by the broadcast receiving section, reception of the broadcast by delivering the channel control information designating the channel to the broadcast receiving section, and for generating output switching information for switching between an output of the broadcast receiving section and an output of the expansion service providing section to select the output to be used; and an output section for outputting information based on the output of the broadcast receiving section or the output of the expansion service providing section switched in response to the output switching information from the channel control section.

The broadcast receiving apparatus in accordance with the present invention is configured in such a manner as to make a decision on whether the expansion service, the added function, is valid or not, and to add it as a channel only when it is valid. Accordingly, it can offer a user only valid expansion services among the expansion services provided as added functions through the channel operation.

### BRIEF DESCRIPTION OF THE DRAWINGS

FIG. 1 is a block diagram showing a configuration of a broadcast receiving apparatus of an embodiment 1 in accordance with the present invention;

FIG. 2 is a diagram showing a configuration of a remote control used in the broadcast receiving apparatus of the embodiment 1 in accordance with the present invention;

FIG. 3 is a diagram showing a structure of a channel control table used in the broadcast receiving apparatus of the embodiment 1 in accordance with the present invention;

FIG. 4 is a block diagram showing a configuration of a digital broadcast receiving section of the broadcast receiving apparatus of the embodiment 1 in accordance with the present invention;

FIG. 5 is a block diagram showing a configuration of the digital broadcast receiving section of the broadcast receiving apparatus of the embodiment 1 in accordance with the present invention;

FIG. 6 is a flowchart illustrating channel control processing carried out in the broadcast receiving apparatus of the embodiment 1 in accordance with the present invention;

FIG. 7 is a block diagram showing a configuration of an expansion service providing section for implementing a car navigation service in the broadcast receiving apparatus of an embodiment 2 in accordance with the present invention;

FIG. 8 is a block diagram showing a configuration of the expansion service providing section for implementing an electronic map display service in the broadcast receiving apparatus of the embodiment 2 in accordance with the present invention;

FIG. 9 is a block diagram showing a configuration of the expansion service providing section for implementing an electronic mail service in the broadcast receiving apparatus of the embodiment 2 in accordance with the present invention;

FIG. 10 is a block diagram showing a configuration of the expansion service providing section for implementing a camera video display service in the broadcast receiving apparatus of the embodiment 2 in accordance with the present invention;

FIG. 11 is a block diagram showing a configuration of the expansion service providing section for implementing a recorded video playback service in the broadcast receiving apparatus of the embodiment 2 in accordance with the present invention;

FIG. 12 is a block diagram showing a configuration of the expansion service providing section for implementing a program guide providing service in the broadcast receiving apparatus of the embodiment 2 in accordance with the present invention;

FIG. 13 is a diagram showing an example of an channel sequence alteration screen used for changing the channel sequence in the broadcast receiving apparatus of an embodiment 3 in accordance with the present invention;

FIG. 14 is a diagram showing a state in which a channel control table is changed in connection with the changes of the channel sequence in the broadcast receiving apparatus of the embodiment 3 in accordance with the present invention;

FIG. 15 is a flowchart illustrating channel sequence alteration processing in the broadcast receiving apparatus of the embodiment 3 in accordance with the present invention;

FIG. 16 is a diagram illustrating a touch screen used as an input section in the broadcast receiving apparatus of an embodiment 4 in accordance with the present invention;

FIG. 17 is a diagram showing a structure of the channel control table used in the broadcast receiving apparatus of the embodiment 4 in accordance with the present invention;

FIG. 18 is a diagram illustrating a handwritten character alteration screen used on the broadcast receiving apparatus of the embodiment 4 in accordance with the present invention;

FIG. 19 is a diagram illustrating information stored in the channel control table in the broadcast receiving apparatus of the embodiment 4 in accordance with the present invention; and

FIG. 20 is a block diagram showing a configuration of the digital broadcast receiving section used in the broadcast receiving apparatus of an embodiment 5 in accordance with the present invention.

### BEST MODE FOR CARRYING OUT THE INVENTION

The best mode for carrying out the invention will now be described with reference to the accompanying drawings to explain the present invention in more detail. Although a digital terrestrial broadcast receiver will be explained as an example of the broadcast receiving apparatus in the following description, the present invention is not limited to the digital terrestrial broadcast receiver, but is applicable to various types of broadcast receivers such as analog broadcast receivers.

### Embodiment 1

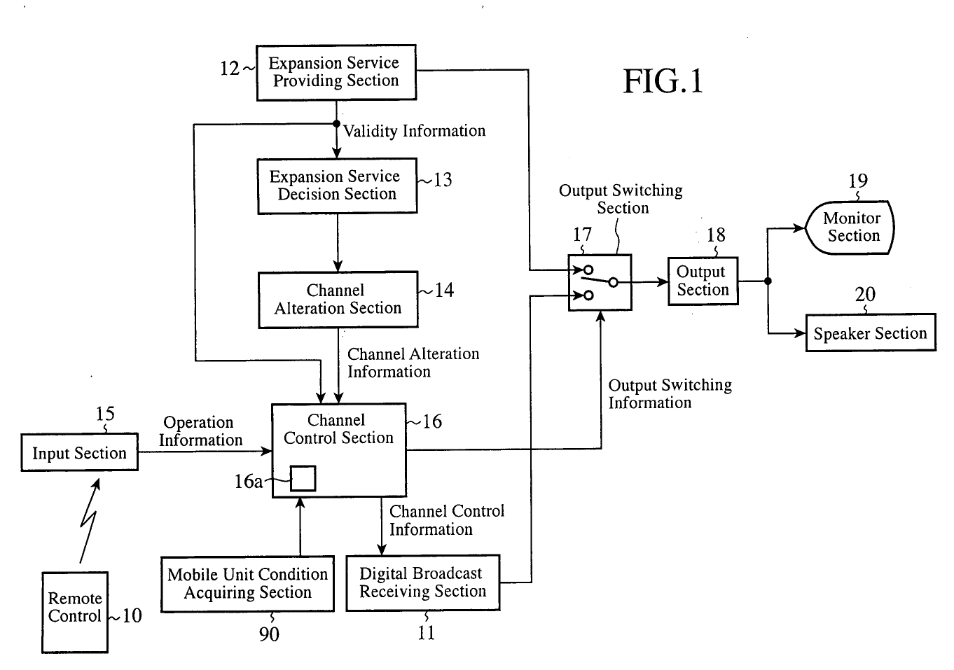

FIG. 1 is a block diagram showing a configuration of a broadcast receiving apparatus of an embodiment 1 in accordance with the present invention. The broadcast receiving apparatus comprises a digital broadcast receiving section 11, an expansion service providing section 12, an expansion service decision section 13, a channel alteration section 14, an input section 15, a channel control section 16, an output switching section 17, an output section 18, a monitor section 19 and a speaker section 20.

The digital broadcast receiving section 11 receives a digital terrestrial broadcast with a frequency set by the channel control information delivered from the channel control section 16. The digital broadcast receiving section 11 delivers the video output information and audio output information, which are obtained by receiving the digital terrestrial broadcast, to the output section 18 via the output switching section 17. The digital broadcast receiving section 11 will be described in more detail later.

The expansion service providing section 12 offers in addition to the television broadcast receiving function, which is the basic function of the broadcast receiving apparatus, an expansion service as an added function. The broadcast receiving apparatus of the present embodiment 1 is assumed to offer a WEB browser service as the expansion service. The expansion service providing section 12 delivers the video output information and audio output information, which are obtained by interpreting the contents acquired by the WEB browser, to the output section 18 via the output switching section 17. In addition, the expansion service providing section 12 delivers validity information, which indicates whether the expansion service is effective or not, that is, the validity of the expansion service, to the expansion service decision section 13 and channel control section 16. The expansion service providing section 12 will be described in more detail later.

The expansion service decision section 13 makes a decision as to whether the WEB browser service in the expansion service providing section 12 is valid or not according to the validity information delivered from the expansion service providing section 12. The expansion service decision section 13 delivers its decision result to the channel alteration section 14.

When the decision result delivered from the expansion service decision section 13 indicates that the expansion service is valid, the channel alteration section 14 generates the channel alteration information for adding the WEB browser service offered by the expansion service providing section 12 as one channel. In contrast, when the decision result delivered from the expansion service decision section 13 indicates that the expansion service changes from valid to invalid, the channel alteration section 14 generates the channel alteration information for deleting the channel corresponding to the additional WEB browser service. The channel alteration information generated by the channel alteration section 14 is delivered to the channel control section 16.

Thus, the operation is dynamically performed in such a way that when the WEB browser service as the expansion service is valid, the expansion service is added to the one channel, and when it changes from valid to invalid, the additional channel is deleted. Accordingly, when the channel is sequentially altered by the channel operation, the invalid expansion service is skipped. This makes it possible to prevent an abnormal picture from being displayed as a Web program as in the conventional Web program read apparatus.

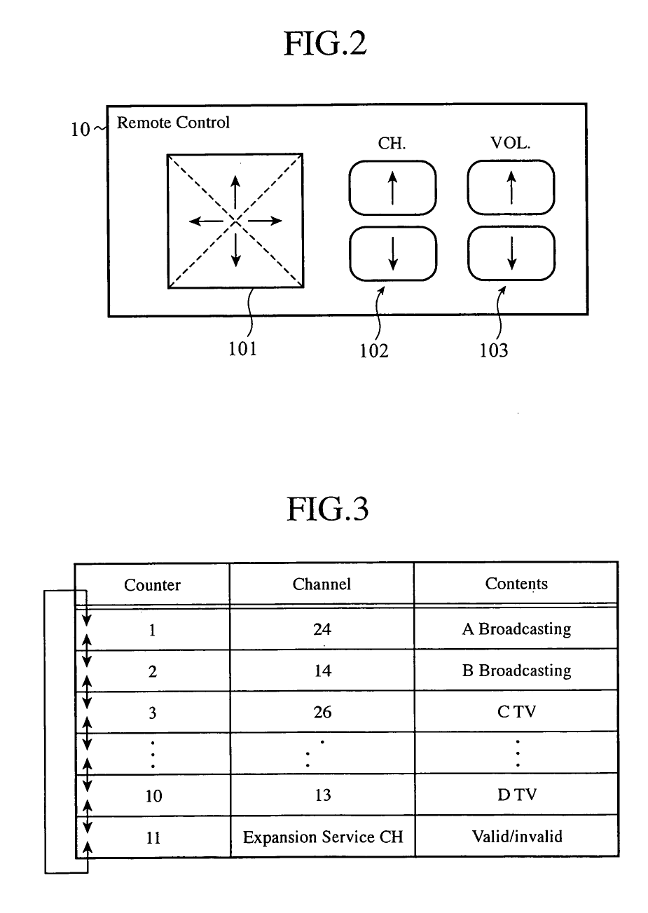

The input section 15 receives a signal transmitted from the remote control 10, for example, and delivers it to the channel control section 16 as the operation information. As shown in FIG. 2, for example, the remote control 10 has a cruciform button 101 for causing a cursor to move up and down, left and right; a channel button (CH.) 102 for increasing or decreasing the channel number; and a volume button (VOL) 103 for increasing or decreasing the volume.

The channel button 102 consists of an up button (↑) and a down button (↓) used for increasing and decreasing the channel number, respectively. Likewise, the volume button 103 consists of an up button (↑) and a down button (↓) used for increasing and decreasing the volume, respectively. In the remote control 10 with such an arrangement, when one of the cruciform button remote control code corresponding to the button pressed is sent to the input section 15. Receiving the remote control code, the input section 15 generates the operation information corresponding to the remote control code, and delivers it to the channel control section 16.

When the operation information delivered from the input section 15 is the channel operation information produced by the operation of the channel button 102, the channel control section 16 selects one channel in response to the channel operation information, generates the output switching information that will cause the selected channel to produce the video and voice output, and delivers it to the output switching section 17. In addition, the channel control section 16 generates the channel control information indicating the frequency of the selected channel, and delivers it to the digital broadcast receiving section 11.

The channel control section 16 stores the channel control table as indicated in FIG. 3. The channel control table is configured in such a manner as to establish correspondence between each value of the counter and a channel of the television broadcast or the channel of the expansion service. In the example as shown in FIG. 3, the counter values 1-10 are associated with the television broadcasting channels, and the counter value 11 is associated with the expansion service channel (CH). The addition and deletion of the expansion service channel to and from the channel control table is made in accordance with the channel alteration information delivered from the channel alteration section 14. The expansion service channel is further provided with the information indicating whether the expansion service is valid or invalid. The channel control section 16 switches between the valid and invalid states of the expansion service channel in response to the validity information delivered from the expansion service providing section 12.

In response to the output switching information delivered from the channel control section 16, the output switching section 17 switches between the digital broadcast receiving section 11 and the expansion service providing section 12 to receive the output source. The output switching section 17 delivers its output to the output section 18.

The output section 18 converts the video output information delivered from the expansion service providing section 12 or from the digital broadcast receiving section 11 via the output switching section 17 to the video signal and delivers it to the monitor section 19. Likewise, it converts the audio output information to the audio signal and delivers it to the speaker section 20. The monitor section 19, which consists of a liquid crystal display, for example, displays a video in accordance with the video signal received from the output section 18. The speaker section 20 outputs the audio in accordance with the audio signal received from the output section 18.

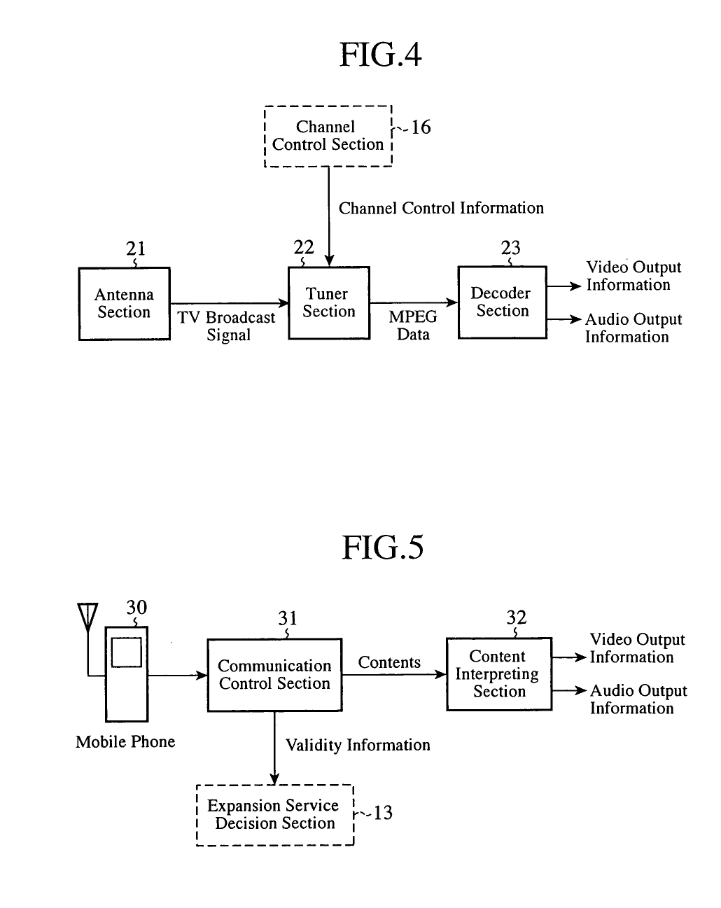

Next, the details of the foregoing digital broadcast receiving section 11 will be described. FIG. 4 is a block diagram showing a detailed configuration of the digital broadcast receiving section 11. The digital broadcast receiving section 11 includes an antenna section 21, a tuner section 22 and a decoder section 23.

The antenna section 21 receives television broadcasting waves of the digital terrestrial broadcasting, converts them to an electric signal, and delivers it to the tuner section 22 as television broadcasting signals. As for the signal with the frequency indicated by the channel control information delivered from the channel control section 16 among the television broadcasting signals delivered from the antenna section 21, the tuner section 22 carries out high frequency signal processing and demodulation processing to generate MPEG (Moving Picture Experts Group) data. The MPEG data generated by the tuner section 22 is delivered to the decoder section 23.

The decoder section 23 performs demultiplexing processing on the MPEG data delivered from the tuner section 22, and separates it to MPEG video data and MPEG audio data. Then, it performs decoding processing on the MPEG video data separated to generate the video output information, and decoding processing on the MPEG audio data to generate the audio output information. The video output information and audio output information generated by the decoder section 23 are delivered to the output switching section 17. Although the MPEG data includes MPEG additional data for data broadcasting besides the MPEG video data and MPEG audio data, the description thereof will be omitted here.

Next, the details of the foregoing expansion service providing section 12 will be described. FIG. 5 is a block diagram showing a detailed configuration of the expansion service providing section 12. The expansion service providing section 12 comprises a communication control section 31 to which a mobile phone 30 is connected and a content interpreting section 32.

The communication control section 31 makes a dial-up connection to the Internet in response to the control of the mobile phone 30, obtains contents offered by a WWW server (not shown) on the Internet, and delivers the contents to the content interpreting section 32. In addition, in response to the radio wave conditions received from the mobile phone 30, the communication control section 31 delivers the validity information indicating the appropriateness of the communication to the expansion service decision section 13. More specifically, the communication control section 31 continuously monitors the radio wave state of the mobile phone 30, and when the radio wave state becomes an “out of range” level, it delivers the validity information indicating “communication disabled” to the expansion service decision section 13. The radio wave state corresponds to the antenna level shown on the mobile phone 30. Although the “communication disabled” is assumed at the “out of range” level here, a configuration is also possible which makes an appropriateness decision of the communication using the “radio wave level 1” (the condition showing one antenna standing) as a threshold value.

The content interpreting section 32 interprets the HTML (HyperText Markup Language) of the contents received from the communication control section 31, converts the contents to video data, and delivers it to the output switching section 17 as the video output information. In addition, the content interpreting section 32 carries out voice synthesis processing for character information included in the contents to generate voice data for reading the contents, and delivers it to the output switching section 17 as the audio output information.

Although the foregoing broadcast receiving apparatus is configured in such a manner as to be connected to the Internet via the mobile phone 30, this is not essential. For example, it can also be configured in such a manner as to be connected to the Internet via a wireless LAN (Local Area Network) or a wireless device such as a DSRC (Dedicated Short Range Communication), or via a cable device such as a LAN cable. In this case, according to the radio wave conditions of the wireless communication or the communication conditions of the LAN cable, such a configuration is also possible which tests the validity of the WEB browser service offered by the expansion service providing section 12.

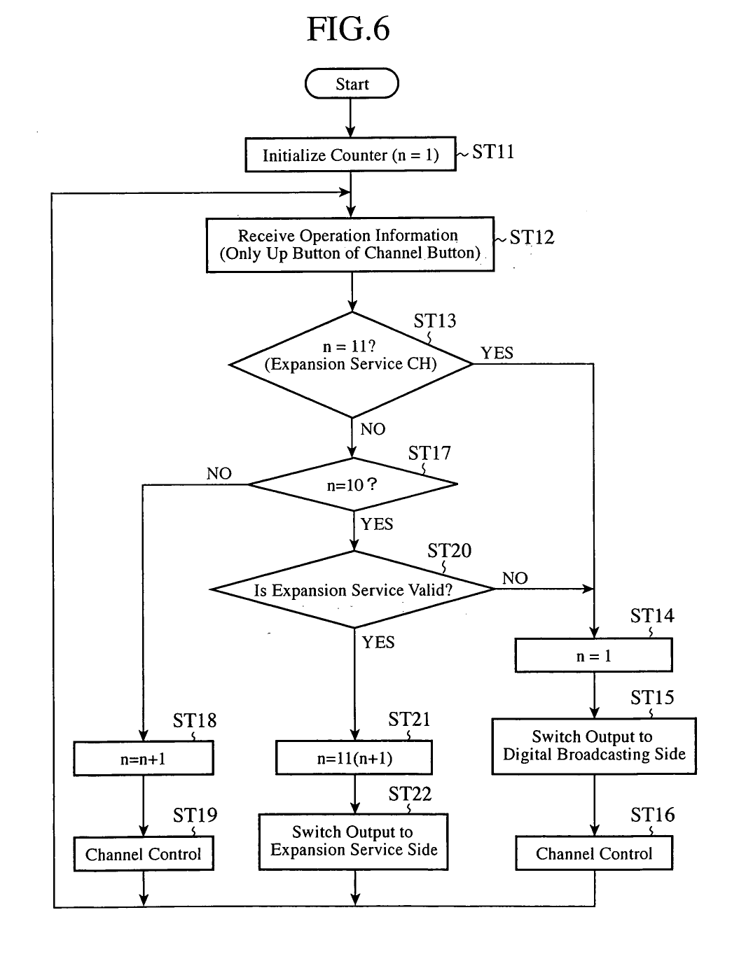

Next, the channel control processing carried out by the broadcast receiving apparatus of the embodiment 1 in accordance with the present invention with the foregoing configuration will be described with reference to the flowchart illustrated in FIG. 6. It is assumed here that the channel control table stores the information shown in FIG. 3.

When a user depresses the up button or down button of the channel button 102 of the remote control 10, the remote control 10 delivers to the input section 15 the remote control code corresponding to the depressed up button or down button. Receiving the remote control code, the input section 15 generates the operation information corresponding to the remote control code and delivers it to the channel control section 16. If the channel control section 16 makes a decision that the operation information delivered from the input section 15 indicates the depression of the up button or down button of the channel button 102, it starts the channel control processing. Since the channel switching processing for the digital broadcast receiving section 11 is the same as that of the conventional digital broadcast receiver, the detailed description thereof is omitted here.

When the channel control processing is started, the counter is initialized (step ST11). More specifically, the content n of the counter included in the channel control section 16 is set at “1”. Subsequently, the operation information is received (step ST12). It is assumed here that the received operation information indicates that the up button of the channel button 102 is depressed. Subsequently, a decision is made as to whether the content n of the counter is “11”, that is, whether it indicates the expansion service channel or not (step ST13).

At step ST13, if a decision is made that the content n of the counter “11”, the content n of the counter is set at “1” (step ST14). Subsequently, the output is switched to a digital broadcasting side (step ST15). More specifically, the channel control section 16 delivers the output switching information to the output switching section 17 to make switching in such a manner that the output of the digital broadcast receiving section 11 is delivered to the output section 18 via the output switching section 17. Subsequently, the channel control is carried out (step ST16). More specifically, the channel control section 16, referring to the channel control table, delivers the channel control information indicating the frequency of the channel whose counter value corresponds to “1” (channel 24 in the example of FIG. 3) to the digital broadcast receiving section 11. Thus, the digital broadcast receiving section 11 receives the digital broadcasting wave of the 24th channel (A broadcasting), and outputs the video output information and audio output information. Then, the video output information output from the digital broadcast receiving section 11 is reproduced to be displayed on the monitor section 19, and the voice based on the audio output information is reproduced to be output from the speaker section 20. After that, the sequence is returned to step ST12 to repeat the foregoing processing.

At the foregoing step ST13, if a decision is made that the content n of the counter is not “11”, then a decision is made whether the content n of the counter is “10” or not (step ST17). At step ST17, if a decision is made that the content n of the counter is not “10”, the content n of the counter is incremented (+1) (step ST18). Subsequently, the channel control is carried out (step ST19). More specifically, the channel control section 16, referring to the channel control table, delivers the channel control information indicating the frequency of the channel whose counter value corresponds to “n+1” to the digital broadcast receiving section 11. Thus, the digital broadcast receiving section 11 receives the digital broadcasting wave of the channel corresponding to the counter content n+1, and outputs the video output information and audio output information. Then, the video output information output from the digital broadcast receiving section 11 is reproduced to be displayed on the monitor section 19, and the voice based on the audio output information is reproduced to be output from the speaker section 20. After that, the sequence is returned to step ST12 to repeat the foregoing processing.

At the foregoing step ST17, if a decision is made that the content n of the counter is “10”, a decision is made whether the expansion service of the expansion service channel corresponding to the counter value “11” of the channel control table is valid or not (step ST20). If a decision is made at step ST20 that it is not valid, the sequence proceeds to step ST14 to carry out the foregoing processing. Accordingly, when the user selects an invalid expansion channel, the channel is skipped.

At the foregoing step ST20, if a decision is made that the expansion service is valid, the content n of the counter is incremented (+1) to “n=11” (step ST21). Subsequently, the output is switched to the expansion service side (step ST22). More specifically, the channel control section 16 delivers the output switching information to the output switching section 17 to make switching in such a manner that the output of the expansion service providing section 12 is delivered to the output section 18 via the output switching section 17. Thus, the video output information output from the expansion service providing section 12 is reproduced to be displayed on the monitor section 19, and the voice based on the audio output information is reproduced to be output from the speaker section 20. After that, the sequence is returned to step ST12 to repeat the foregoing processing.

Incidentally, although only the processing at the time when the up button of the channel button 102 is depressed is described in the channel control processing as shown in FIG. 6, the processing at the time when the down button of the channel button 102 is depressed can be implemented in the same processing. In addition, although the final channel number is made “10” in the channel control processing as shown in FIG. 6, the final channel number is not limited to “10” but is arbitrarily set. Furthermore, although the initial value of the counter is made “1”, such a configuration is also possible that uses a value stored when the power is turned off is used as the initial value.

Besides, although the foregoing broadcast receiving apparatus is configured in such a manner as to increase or decrease the channel number by operating the remote control 10, this is not essential. For example, a configuration is also possible which increases or decreases the channel number using the touch screen or voice operation.

In addition, although the foregoing example is configured in such a manner as to decide the validity of the expansion service by using the radio wave level (antenna level) of the mobile phone 30, this is not essential. For example, a configuration is also possible which decides the validity of the expansion service according to whether the mobile phone 30 necessary for the communication is connected or not, whether the power supply of the mobile phone 30 connected is in the on state or not, whether it is possible to access a WWW server or not, or whether an error rate (data error rate during communication) of the contents from the WWW server is less than a prescribed value or not.

Furthermore, considering that the communication with the mobile phone 30 entails communication cost, such a configuration is also possible in which the user, using a menu on the screen and operation buttons of the mobile phone 30, causes an information storing section within the communication control section 31 to store information as to whether to “do/not do” communication, and according to the stored information, the expansion service decision section 13 decides the validity of the expansion service.

Moreover, such a configuration is also possible in which the channel control section 16 includes an information storing section for keeping information indicating whether the expansion service is valid or not in advance, and according to the information acquired from the information storing section, the expansion service decision section 13 makes a decision as to whether the expansion service is valid or not. In this case, the channel control section 16 can further include an information alteration section for varying the information stored in the information storing section in response to the operation information from the input section 15.

### Embodiment 2

Although the foregoing embodiment 1 is described by taking the WEB browser service as an example of the expansion service provided by the expansion service providing section 12, the present embodiment 2 is configured in such a manner that the expansion service providing section 12 provides expansion services other than the WEB browser service.

As for the configuration and operation of the broadcast receiving apparatus of the present embodiment 2, they are the same as those of the broadcast receiving apparatus of the embodiment 1 except for the type of the expansion service and the validity decision method of the expansion service. Accordingly, in the following description, the focus of the explanation will be placed on the type of the expansion service and the validity decision method of the expansion service.

### (1) Car Navigation Service

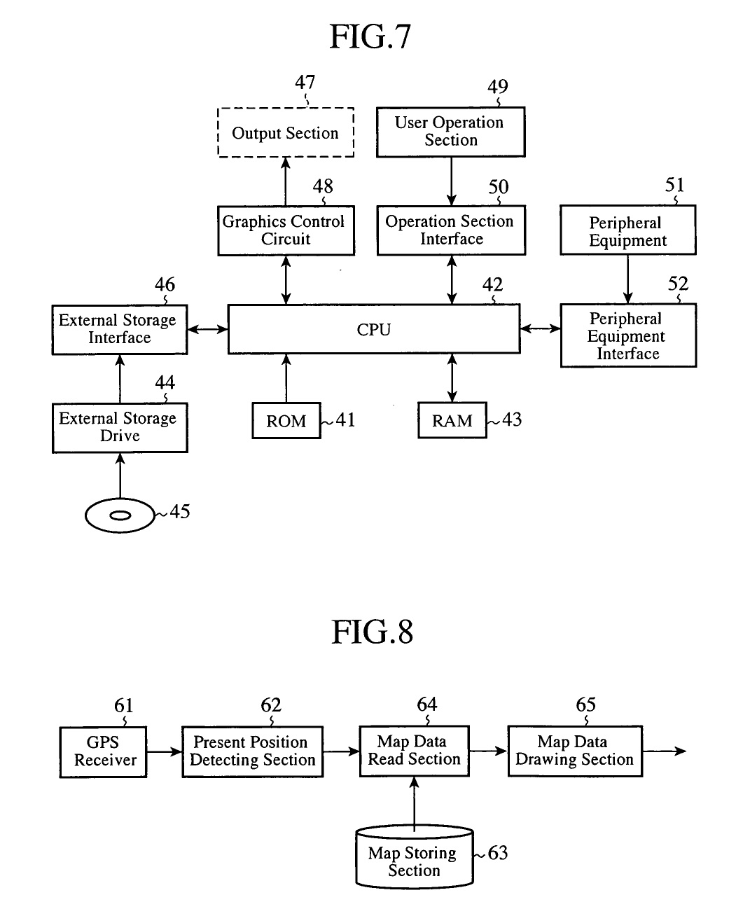

To implement the car navigation service, a car navigation apparatus is used as the expansion service providing section 12. FIG. 7 is a block diagram showing a hardware configuration of the car navigation apparatus used as the expansion service providing section 12.

The car navigation apparatus comprises a ROM (Read Only Memory) 41, a CPU (Central Processing Unit) 42, a RAM (Random Access Memory) 43, an external storage drive 44, an external storing medium 45, an external storage interface 46, an output section 47, a graphics control circuit 48, a user operation section 49, an operation section interface 50, peripheral equipment 51 and a peripheral equipment interface 52.

The ROM 41 stores a car navigation program. The CPU 42 reads the car navigation program for implementing the navigation functions from the ROM 41 and executes it. The RAM 43 temporarily stores the program and data during the time when the CPU 41 executes the car navigation program.

The external storage drive 44 reads data from the external storing medium 45, and delivers it to the external storage interface 46. The external storing medium 45 consists of such a medium as a DVD-ROM (Digital Versatile Disk Read Only Memory), a CD-ROM (Compact Disk Read Only Memory) or a HDD (Hard Disk Drive), and stores a map database and the like. The external storage interface 46 controls the data transfer between the CPU 41 and the external storage drive 44.

The output section 47 is common to the output section 18, monitor section 19 and speaker section 20 of the digital broadcast receiving apparatus of the embodiment 1. The monitor section 19 included in the output section 47 displays an image in accordance with the display data delivered from the graphics control circuit 48. The graphics control circuit 48 draws an image on the monitor section 19 in accordance with a drawing instruction delivered from the CPU 41.

The user operation section 49 includes, for example, a remote control, various switches and a touch screen. The operation data generated by operating the user operation section 49 is delivered to the operation section interface 50. The operation section interface 50 controls the data transfer between the CPU 41 and the user operation section 49.

The peripheral equipment 51 includes, for example, a GPS (Global Positioning System) receiver, a gyroscope, and a vehicle speed pulse sensor. The data generated by the peripheral equipment 51 is delivered to the peripheral equipment interface 52. The peripheral equipment interface 52 controls the data transfer between the peripheral equipment 51 and the CPU 41.

Since the operation of the car navigation apparatus with the foregoing configuration is the same as that of an ordinary car navigation apparatus, the description thereof is omitted here.

Next, the validity decision method of the car navigation service will be described. A configuration is possible which makes a decision as to whether the car navigation service is valid or not according to the GPS reception level in the GPS receiver included in the peripheral equipment 51, that is, according to the number of GPS satellites captured. Alternatively, a configuration is possible which makes the validity decision according to the presence or absence of the external storing medium 45, that is, according to the presence or absence of the external storing medium that stores the map database. Alternatively, a configuration is also possible which makes the validity decision according to operation conditions of the car navigation apparatus, that is, according to whether the car navigation apparatus operates normally or abnormally. Alternatively, a configuration is possible which makes the validity decision according to power supply conditions of the car navigation apparatus. Alternatively, a configuration is possible which makes the validity decision according to the presence or absence of the vehicle speed pulses from the vehicle speed pulse sensor included in the peripheral equipment 51.

### (2) Electronic Map Display Service

The electronic map display service is a part of the car navigation service specialized in map display, that is, a part of the car navigation service excluding the route search and route guidance therefrom. In other words, it is the same service as an electronic atlas provided for personal computers.

FIG. 8 is a block diagram showing a configuration of an electronic map display apparatus used as the expansion service providing section 12 for providing the electronic map display service. The electronic map display apparatus includes a GPS receiver 61, a present position detecting section 62, a map storing section 63, a map data read section 64 and a map data drawing section 65. The operation of the electronic map display apparatus is the same as the processing of the electronic atlas implemented by a personal computer and the like.

More specifically, the GPS receiver 61 receives GPS signals transmitted from GPS satellites, and delivers them to the present position detecting section 62. According to the GPS signals delivered from the GPS receiver 61, the present position detecting section 62 detects its own present position, and delivers it to the map data read section 64 as the present position data. The map storing section 63, which includes a hard disk drive (HDD), for example, stores the map data.

The map data read section 64 reads from the map storing section 63 the map data within a prescribed range around the position indicated by the present position data delivered from the present position detecting section 62, and delivers it to the map data drawing section 65. According to the map data delivered from the map data read section 64, the map data drawing section 65 draws the map, and delivers it to the output switching section 17 as the video output information (see FIG. 1). Here, as the map storing section 63, a storing medium such as a memory card can also be used besides the hard disk.

Next, the validity decision method of the electronic map display service will be described. Whether the electronic map display service is valid or not can be decided according to the reception level of the GPS signals at the GPS receiver 61, that is, according to the number of the GPS satellites captured. Alternatively, the validity decision can be made according to conditions of the map storing section 63, that is, according to the presence or absence of the hard disk or memory card device or the presence or absence of a fault. Alternatively, the validity decision can be made according to the presence or absence of the map data corresponding to the present position detected from the GPS signals fed from the GPS receiver 61.

### (3) Facility Information Providing Service

The facility information providing service is a part of the car navigation service specialized in facility information provision, that is, apart of the car navigation service excluding the route search and route guidance therefrom.

The expansion service providing section 12 for offering the facility information providing service is configured in such a manner that in the configuration for providing the electronic map display service as shown in FIG. 8, the map storing section 63 stores facility data, the map data read section 64 reads the facility data from the map storing section 63, and the map data drawing section 65 displays information about the facilities according to the facility data delivered from the map data read section 64.

Next, the validity decision method of the facility information providing service will be described. Whether the facility information providing service is valid or not can be decided according to the reception level of the GPS signals at the GPS receiver 61, that is, according to the number of the GPS satellites captured. Alternatively, the validity decision can be made according to conditions of the map storing section 63, that is, according to the presence or absence of the hard disk or memory card device or the presence or absence of a fault. Alternatively, the validity decision can be made according to the presence or absence of the map data corresponding to the present position detected from the GPS signals.

### (4) Electronic Mail Service

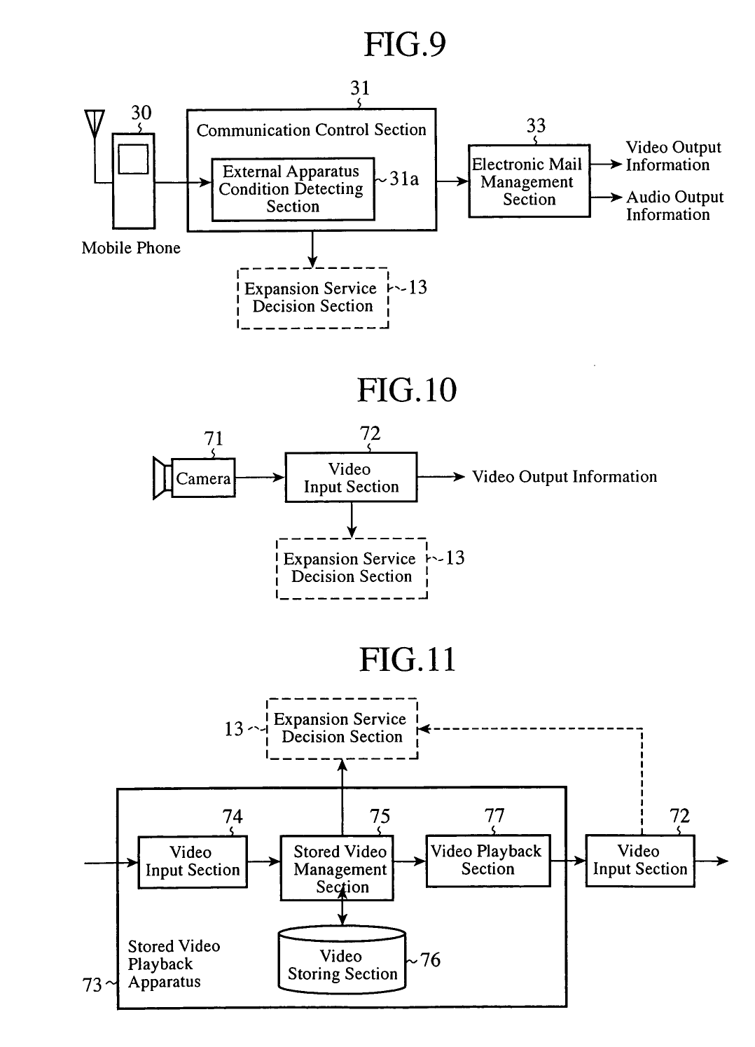

FIG. 9 is a block diagram showing a configuration of the expansion service providing section 12 for implementing the electronic mail service. The expansion service providing section 12 includes a communication control section 31 connected to a mobile phone 30 and an electronic mail management section 33.

The communication control section 31 is the same as that of the expansion service providing section 12 for the WEB browser service as shown in FIG. 5 except that it includes an external apparatus condition detecting section 31a. The external apparatus condition detecting section 31a detects whether the mobile phone 30 is connected or not.

The electronic mail management section 33 interprets the text or HTML of electronic mail received from the communication control section 31, converts the electronic mail to video data, and delivers it to the output switching section 17 as the video output information. In addition, the electronic mail management section 33 performs voice synthesis processing of the character information in the electronic mail, generates voice data for reading the electronic mail, and delivers it to the output switching section 17 as the audio output information.

Next, the validity decision method of the electronic mail service will be described. A configuration is possible which makes a decision as to whether the electronic mail service is valid or not by detecting whether the mobile phone 30 is connected or not by the external apparatus condition detecting section 31a. Alternatively, a configuration is possible which makes a decision according to the radio wave conditions of the mobile phone 30, that is, according to the antenna level. Alternatively, a configuration is possible which makes a decision by the presence or absence of the received electronic mail.

### (5) Camera Video Display Service

The camera video display service is a service for displaying the video of a front camera or rear camera mounted on a vehicle, for example. The camera image service is used for checking the rear on the video at the parking, or for checking the front on the video at the start, for example.

FIG. 10 is a block diagram showing a configuration of the expansion service providing section 12 for implementing the camera image service. The expansion service providing section 12 includes a camera 71 and a video input section 72.

The camera 71 delivers to the video input section 72 a camera video signal acquired by shooting ahead or behind the vehicle. The video input section 72 performs prescribed processing on the camera video signal delivered from the camera 71, and delivers it to the output switching section 17 as the video output information. In addition, the video input section 72 decides the validity of the camera video display service, and delivers the result to the expansion service decision section 13 as the validity information.

Next, the validity decision method of the camera video display service will be described. A configuration is possible which makes a decision as to whether the camera video display service is valid or not according to the presence or absence of the connection of the camera 71. Alternatively, a configuration is possible which makes the validity decision according to the conditions of the camera video signal, that is, according to whether the camera video signal is normal or not.

### (6) Recorded Video Playback Service

FIG. 11 is a block diagram showing a configuration of the expansion service providing section 12 for implementing the recorded video playback service. The expansion service providing section 12 includes a stored video playback apparatus 73 and a video input section 72.

The stored video playback apparatus 73 stores the video data delivered from the outside, and generates the video signal by playing back the stored video data. The stored video playback apparatus 73 includes a video input section 74, a stored video management section 75, a video storing section 76 and a video playback section 77. The video input section 74 delivers the video data delivered from the outside to the stored video management section 75. The stored video management section 76 stores the video data received from the video input section 74 into the video storing section 76, and reads the video data stored in the video storing section 76 and delivers it to the video playback section 77. In addition, the stored video management section 75 decides the validity of the recorded video playback service, and delivers the result to the expansion service decision section 13 as the validity information. The video playback section 77 reproduces the video signal based on the video data delivered from the stored video management section 75, and delivers it to the video input section 72.

The video input section 72 performs prescribed processing on the video signal delivered from the stored video playback apparatus 73, and delivers it to the output switching section 17 as the video output information. The video input section 72 can be configured in such a manner as to decide the validity in the recorded video playback service, and to deliver the result to the expansion service decision section 13 as the validity information.

Next, the validity decision method of the recorded video playback service will be described. A configuration is possible which makes a decision as to whether the recorded video playback service is valid or not according to the presence or absence of the recorded video to be played back. Alternatively, a configuration is possible which makes the validity decision according to the presence or absence of the video input from the recorded video playback apparatus 73. Alternatively, a configuration is possible which makes the validity decision according to whether the power supply of the recorded video playback apparatus 73 is in the on state or not.

### (7) Program Guide Providing Service

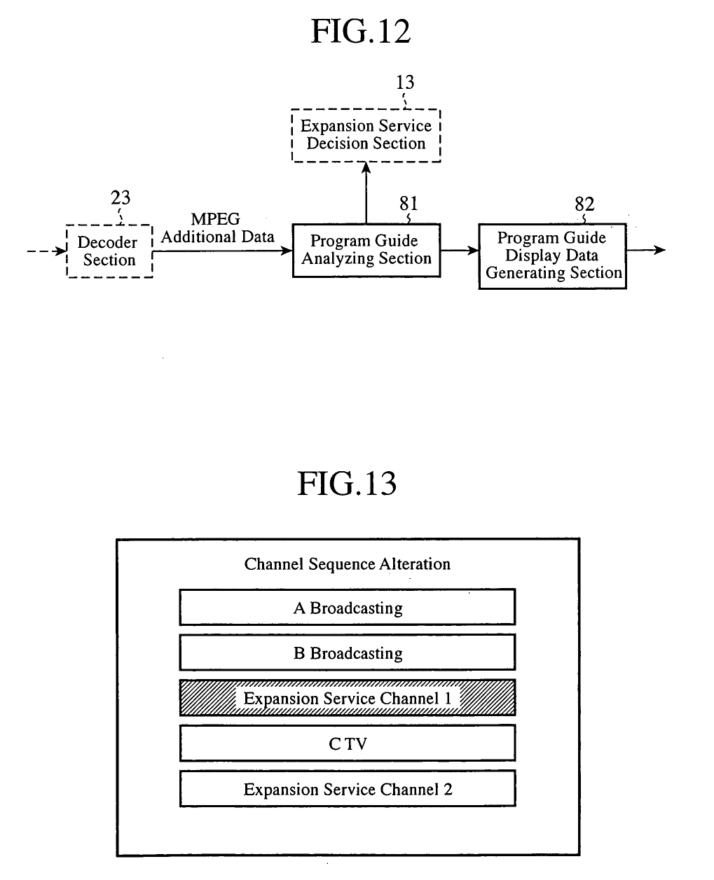

FIG. 12 is a block diagram showing a configuration of the expansion service providing section 12 for implementing the program guide providing service. The expansion service providing section 12 comprises a program guide analyzing section 81 and a program guide display data generating section 82.

To the program guide analyzing section 81, the decoder section 23 of the digital broadcast receiving section 11 (see FIG. 4) delivers the information about the program guide as MPEG additional data. The program guide analyzing section 81 generates the program guide data by analyzing the MPEG additional data, and delivers it to the program guide display data generating section 82. In addition, the program guide analyzing section 81 makes a validity decision in the program guide providing service, and delivers the result to the expansion service decision section 13 as the validity information. In this case, a configuration is possible which makes a decision as to whether the program guide providing service is valid or not according to whether the program guide information can be obtained from the broadcasting.

The program guide display data generating section 82 generates the display data for displaying the program guide from the program guide data delivered from the program guide analyzing section 81, and delivers it to the output switching section 17 as the video output information. Although the foregoing example obtains the program guide information from the broadcasting as the MPEG additional data, this is not essential. For example, a configuration is possible which obtains the program guide information from a site on the Internet by connecting to the Internet as in the WWW browser service.

### (8) Data Broadcasting Providing Service

The data broadcasting providing service provides the service by obtaining the data for the data broadcasting from the MPEG additional data as in the program guide providing service. In this case, a configuration is possible which makes a decision as to whether the data broadcasting providing service is valid or not according to whether or not the data for the data broadcasting is available.

### (9) Traffic Information Providing Service

The traffic information providing service is a service for displaying the VICS (Vehicle Information and Communication System) traffic information. The expansion service providing section 12 for implementing the traffic information providing service comprises a VICS receiver. Since the configuration and operation of the VICS receiver are well known, their description will be omitted here.

Next, the validity decision method of the traffic information providing service will be described. A configuration is possible which makes a decision as to whether the traffic information providing service is valid or not according to the presence or absence of the VICS data. Alternatively, a configuration is possible which makes the validity decision according to the presence or absence of the VICS data corresponding to the vehicle location, that is, according to whether the traffic information is meaningful for the user or not.

Although the foregoing example is configured in such a manner as to receive the VICS data with the VICS receiver, the VICS data can be received from the Internet as in the WWW browser service, or from the broadcasting as in the data broadcasting providing service. As for the validity decision method in these cases, it is the same as described before.

### (10) Music Playback Service

The music playback service includes not only services provided by conventional audio equipment, but also services of playing back music by a portable music player such as a portable audio player with a built-in hard disk and a mobile phone with a built-in audio function, which are connected to a broadcast receiving apparatus with a CD playback function. The expansion service providing section 12 for implementing the music playback service comprises a portable music player. The portable music player is connected to the broadcast receiving apparatus via a cable so that the portable music player transmits the music playback data to the broadcast receiving apparatus, and the broadcast receiving apparatus transmits control data (playback, stop and the like) to the portable music player.

In this case, a configuration is possible which makes a decision as to whether or not a CD is present in the driver in the audio equipment or whether or not the music playback service is valid according to whether the portable music player is connected or not. Alternatively, a configuration is also possible which makes the validity decision according to whether the portable music player has the playback data or not.

### (11) Still Picture Display Service

The still picture display service is a service of storing still picture data in a picture storing section of a picture playback apparatus (neither of them are shown) as in the foregoing recorded video playback service, and displaying a still picture as a background picture of the monitor section 19 in response to a user instruction.

Next, the validity decision method of the still picture display service will be described. A configuration is possible which makes a decision as to whether the still picture display service is valid or not according to the presence or absence of the data about the still picture to be displayed. Alternatively, a configuration is possible which makes the validity decision according to the presence or absence of the input of the picture data from the picture playback apparatus. Alternatively, a configuration is possible which makes the validity decision according to whether the power supply of the picture playback apparatus is in the on state or not.

In the broadcast receiving apparatus of the present embodiment 2, the expansion service providing section 12 can be configured in such a manner as to provide a plurality of services among the foregoing (1)-(11) services. In this case, a plurality of expansion service channels (CH) are prepared in the channel control table as shown in FIG. 3.

When the broadcast receiving apparatus is mounted on a mobile unit like a vehicle, such a configuration is possible in which a mobile unit condition acquiring section 90 for picking up the vehicle speed pulses is provided, and when the channel control section 16 makes a decision that the vehicle is traveling from the presence or absence of the vehicle speed pulses picked up by the mobile unit condition acquiring section 90, it forcedly selects the expansion service channel of the car navigation service, for example. In addition, when there are a plurality of expansion service channels, a configuration is possible in which the channel control section 16 selects from among them the expansion service channel that makes a transition forcedly in response to the operation information fed from the input section 15 during the traveling, and displays the information of the expansion service channel selected.

Furthermore, such a configuration is also possible in which the channel control section 16 alters the type of the information to be output from the output section 18 in response to the presence or absence of the vehicle speed pulses picked up by the mobile unit condition acquiring section 90. More specifically, when the channel control section 16 makes a decision that the vehicle is traveling according to the vehicle speed pulses picked up by the mobile unit condition acquiring section 90, it causes only the audio to be output. In contrast, such a configuration is also possible in which when it makes a decision that the vehicle is stopped, the channel control section 16 controls the output section 18 in such a manner as to output both the video and audio.

### Embodiment 3

In the broadcast receiving apparatus of the embodiment 1, the position of the expansion service channel is fixed in the channel control table. In contrast, in the broadcast receiving apparatus of the present embodiment 3, the position of the expansion service channel is made variable in the channel control table, and the channels are switched in the sequence in accordance with the contents of the channel control table altered.

The configuration of the broadcast receiving apparatus of the embodiment 3 is the same as that of the broadcast receiving apparatus of the embodiment 1. In addition, the operation of the broadcast receiving apparatus of the embodiment 3 is the same as that of the broadcast receiving apparatus of the embodiment 1 except that the channel sequence is altered.

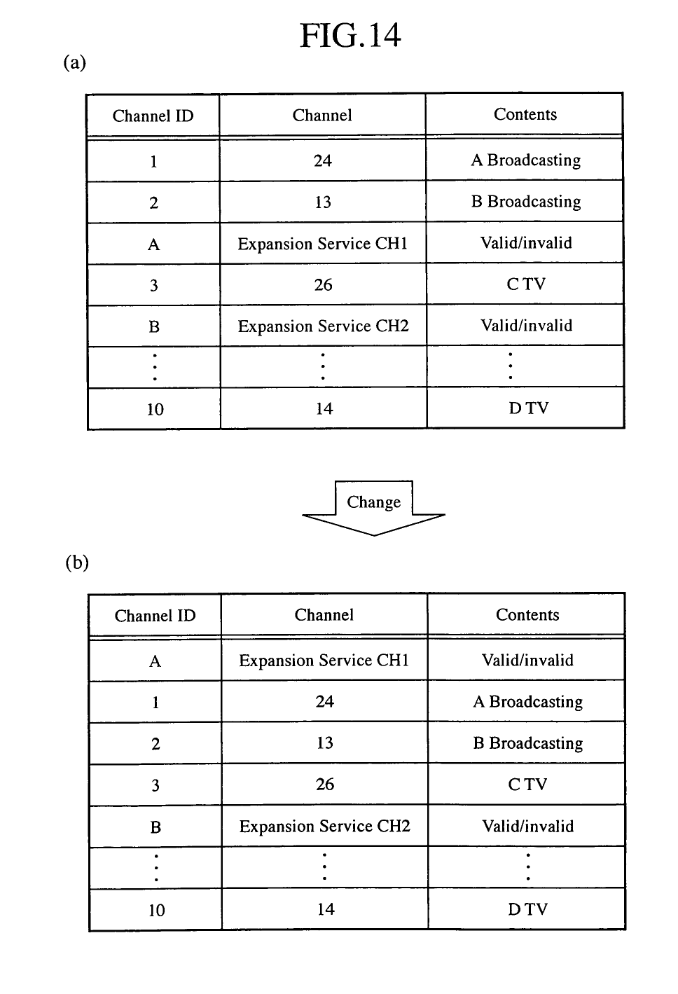

FIG. 13 is a diagram showing an example of a channel sequence alteration screen used for altering the channel sequence. In addition, FIG. 14 is a diagram showing a state in which the channel control table is changed in connection with the channel sequence alteration. The channel sequence is altered when a user selects a channel whose sequence the user wishes to change on the channel sequence alteration screen using the remote control 10 (in FIG. 13, expansion service channel 1 is selected), and moves it to the position (sequence) the user desires. When the channel sequence is altered by the user operation, the contents of the channel control table before the alteration as shown in FIG. 14(a) are altered to the contents as shown in FIG. 14(b).

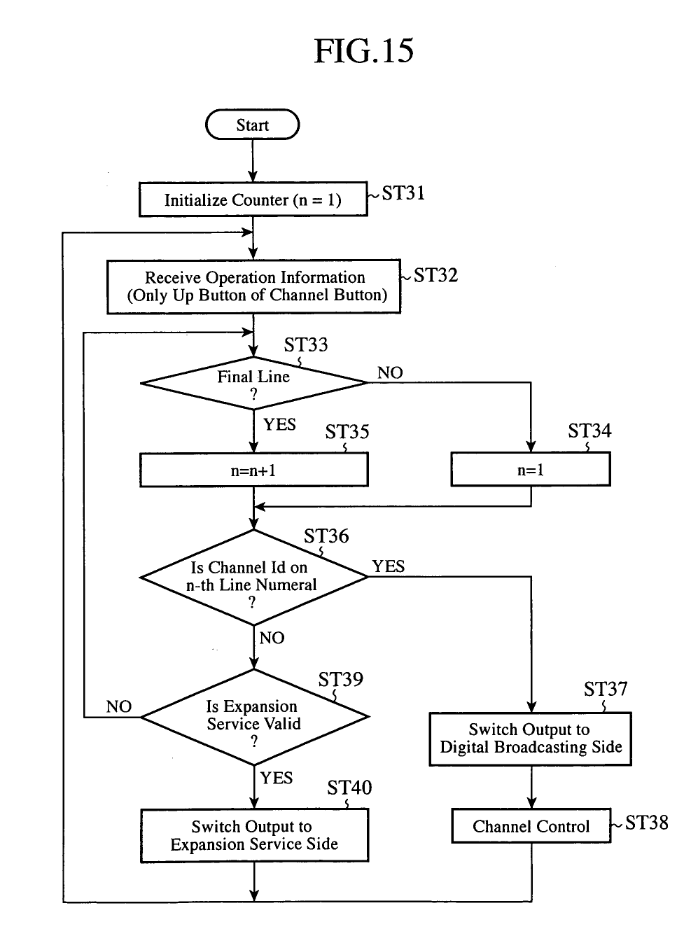

Next, the details of the channel sequence alteration processing carried out by the channel control section 16 will be described with reference to the flowchart illustrated in FIG. 15. The portion of the channel control section 16 that carries out the channel sequence alteration processing corresponds to the channel sequence alteration section in accordance with the present invention.

When the user depresses the up button or down button of the channel button 102 of the remote control 10, the remote control 10 delivers to the input section 15 the remote control code corresponding to the depressed up button or down button. Receiving the remote control code, the input section 15 generates the operation information corresponding to the remote control code and delivers it to the channel control section 16. If the channel control section 16 makes a decision that the operation information delivered from the input section 15 indicates the depression of the up button or down button of the channel button 102, the internal channel sequence alteration section 16a starts the channel sequence alteration processing.

When the channel sequence alteration processing is started, the counter is initialized, first (step ST31). More specifically, the content n of the counter included in the channel control section 16 is set at “1”. Subsequently, the operation information is received (step ST32). It is assumed here that the received operation information indicates that the up button of the channel button 102 is depressed. Subsequently, a decision is made as to whether the content n of the counter indicates the final line of the channel control table or not (step ST33).

At step ST33, if a decision is made that the content n of the counter indicates the final line of the channel control table, the content n of the counter is set at “1” (step ST34), and then the sequence proceeds to step ST36. In contrast, at step ST33, unless a decision is made that the content n of the counter indicates the final line of the channel control table, the content n of the counter is incremented (+1) (step ST35), and then the sequence proceeds to step ST36.

At step ST36, a check is made whether the channel ID of the line the content n of the counter indicates is a numeral or not. At step ST36, if a decision is made that it is a numeral, the output is then switched to the digital broadcasting side (step ST37). More specifically, the channel control section 16 delivers the output switching information to the output switching section 17 to make switching in such a manner that the output of the digital broadcast receiving section 11 is delivered to the output section 18 via the output switching section 17 (step ST38). Specifically, the channel control section 16, referring to the channel control table, delivers to the digital broadcast receiving section 11 the channel control information indicating the frequency of the channel having the channel ID corresponding to the content n of the counter. Thus, the digital broadcast receiving section 11 receives the digital broadcasting wave of the channel corresponding to the content n of the counter, and outputs the video output information and audio output information. Then, the video output information output from the digital broadcast receiving section 11 is reproduced to be displayed on the monitor section 19, and the voice based on the audio output information is reproduced to be output from the speaker section 20. After that, the sequence is returned to step ST32 to repeat the foregoing processing.

At the foregoing step ST36, if a decision is made that the channel ID is not a numeral but the alphabet, then a check is made whether the expansion service of the expansion service channel is valid or not (step ST39). At step ST39, if a decision is made that it is not valid, the sequence proceeds to step ST33 to execute the foregoing processing. In contrast, if a decision is made that the expansion service is valid, the output is switched to the expansion service side (step ST40). More specifically, the channel control section 16 delivers the output switching information to the output switching section 17 to make switching in such a manner that the output of the expansion service providing section 12 is delivered to the output section 18 via the output switching section 17. Thus, the video output information output from the expansion service providing section 12 is reproduced to be displayed on the monitor section 19, and the voice based on the audio output information is reproduced to be output from the speaker section 20. After that, the sequence is returned to step ST32 to repeat the foregoing processing.

Incidentally, although only the processing at the time when the up button of the channel button 102 is depressed is described in the channel sequence alteration processing as shown in FIG. 15, the processing at the time when the down button of the channel button 102 is depressed can be implemented in the same processing. In addition, although the channel sequence alteration processing as illustrated in FIG. 15 is configured in such a manner as to distinguish between the channel ID of the expansion service channel and that of the ordinary digital broadcasting by the alphabet and numeral, thereby making a decision as to whether it is the expansion service channel or not, a configuration is also possible which uses only numerals, and makes a decision that it is the expansion service channel if the numeral is a prescribed value or more.

Besides, although the foregoing example is configured in such a manner as to increase or decrease the channel number by operating the remote control 10 as in embodiment 1, this is not essential. For example, a configuration is also possible which increases or decreases the channel number using the touch screen or voice operation. As for the alteration method of the valid/invalid of the expansion service, it is carried out in the same manner as in the embodiment 1.

Although the foregoing example is configured in such a manner that the user alters the channel sequence, a configuration is also possible in which the broadcast receiving apparatus side alters the channel sequence automatically. For example, such a configuration is also possible which makes a decision that the channel is viewed if the channel alteration is not carried out for a prescribed seconds after the channel is selected, counts the number of times of viewing the channel, and then alters the channel sequence according to the descending order of the number of times of viewing. This makes it possible to set the channel at the highest viewing frequency of the user at the top of the channel sequence.

In addition, although it is not assumed in the foregoing example that different users operate the broadcast receiving apparatus, a configuration is also possible which includes a user identifying section for recognizing a user according to an image from a camera, stores the channel sequences with establishing correspondence between the identified users and the channel sequences, and alters the channel sequence in accordance with the changes of the users.

### Embodiment 4

Although the foregoing embodiments 1-3 are configured in such a manner as to carry out the channel alteration by using the channel button 102 consisting of the up button or the down button, the present embodiment 4 is configured in such a manner as to alter the channel directly by recognizing a handwritten character on a touch screen.

The broadcast receiving apparatus of the present embodiment 4 can be configured in such a manner that the user can set target characters (recognition target information) of the handwriting recognition processing with establishing correspondence between them and the expansion service channels. According to the configuration, since the expansion service channels can be associated with any desired characters, the user can select any one of the expansion service channels through a desired operation.

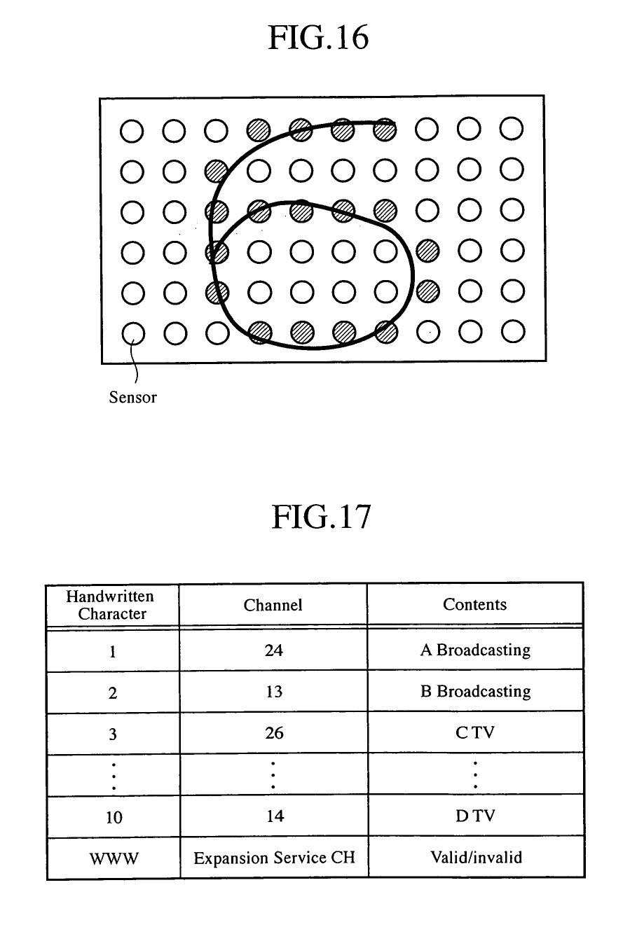

The present embodiment 4 employs a touch screen as the input section 15. As illustrated in FIG. 16, the touch screen is usually constructed by placing sensors at a prescribed resolution so that touch information indicating the sensors the user touches is delivered to the channel control section 16. According to the touch information, the channel control section 16 decides the sensors the user touches, and carries out the recognition processing to identify the character handwritten by the user. Since the recognition processing of a handwritten character on the touch screen is well known, the detailed description thereof will be omitted here.

As shown in FIG. 17, the channel control section 16 stores a channel control table in which each channel is associated with a handwritten character. According to the character obtained as a result of the recognition and the information described in the channel control table, the selection of the channel and the switching processing between the digital broadcasting and the expansion service are carried out.

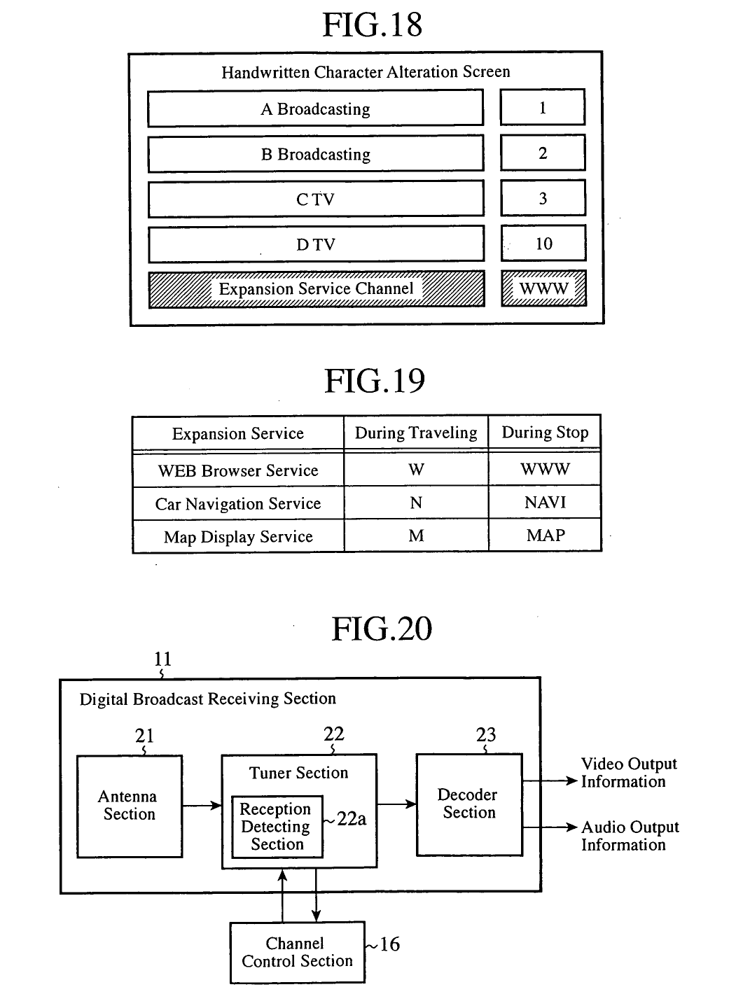

The user operates the handwritten character alteration screen as illustrated in FIG. 18 to set a character or characters associated with the expansion service channel the user wishes to alter on a software keyboard screen not shown (a character input screen used in the input screen of a car navigation apparatus and the like). The set characters are written into the foregoing channel control table. Thus, the information in the channel control table is updated.

Incidentally, when the broadcast receiving apparatus is mounted on a mobile unit like a vehicle, such a configuration is possible in which a mobile unit condition acquiring section 90 for picking up the vehicle speed pulses is provided; and the channel control section 16 alters the type of the handwritten characters depending on the presence or absence of the vehicle speed pulses picked up by the mobile unit condition acquiring section 90, that is, depending on whether the mobile unit is traveling or stopped. In this case, the channel control section 16 stores the channel control table with information as shown in FIG. 19, for example. Thus, character strings with a high handwriting recognition rate are set during a halt, and character strings that can be input easily are set during traveling. This offers an advantage of being able to simplify the input during the traveling though the recognition rate is reduced.

Although the foregoing example is described by way of example of the touch screen operation, the voice operation can also implement the same functions as described above by increasing or decreasing the length of the commands to be subjected to the voice recognition.

Furthermore, although the foregoing example is configured in such a manner that the user sets the handwritten characters, this is not essential. For example, a configuration is also possible which sets handwritten characters in the expansion service providing section 12 in advance, and sets the characters that have been set in advance in the channel control table at the time when the expansion service becomes valid. In addition, the foregoing function is applicable not only to the expansion service, but also to the digital broadcasting. In this case, a configuration is possible which receives characters for operation as the additional data of the digital broadcasting, and sets the received characters in the channel control table.

### Embodiment 5

The broadcast receiving apparatus, which is mounted on a mobile unit such as a vehicle, changes its position as the mobile unit travels. Thus, its reception conditions can sometimes change to a state in which the broadcast receiving apparatus cannot receive the broadcasting normally (referred to as “weak electric field conditions”). In the weak electric field conditions, the broadcasting cannot be provided normally. In view of such a situation, the broadcast receiving apparatus of the present embodiment 5 forcedly switches to the expansion service channel if the weak electric field conditions take place.

FIG. 20 is a block diagram showing a configuration of the digital broadcast receiving section 11 in the embodiment 5. The digital broadcast receiving section 11 comprises an antenna section 21, a tuner section 22 and a decoder section 23. The tuner section 22 further includes a reception detecting section 22a. The reception detecting section 22a detects a data error rate at the time of demodulation (actually, some degree of data error is complemented by an error correcting technique), and delivers it to the channel control section 16. The channel control section 16 receives the data error rate delivered from the reception detecting section 22a of the tuner section 22, and makes a decision of the weak electric field conditions if the data error rate is less than a prescribed threshold value. When the decision is made of the weak electric field conditions, the channel control section 16 carries out the processing of outputting the information of the preset expansion service channel.

Although the foregoing example is configured in such a manner as to alter the channel to the preset expansion service channel, a configuration is also possible which enables the user to set the expansion service to which the switching is made forcedly.

In addition, when there are a plurality of expansion services, a configuration is possible in which each expansion service providing section supplies the channel control section 16 with channel control enabled/disabled information indicating whether the forced switching is possible or not; and the channel control section 16 alters the channel by selecting one expansion service from the switching enabled expansion services. Furthermore, a configuration is also possible in which at that selection, each expansion service providing section transmits priority information to the channel control section 16; and the channel control section 16 selects the expansion service to which the switching is made forcedly in accordance with the priority designated by the priority information.

Although the foregoing example makes the decision about the weak electric field conditions using the data error rate at the demodulation in the tuner section 22, this is not essential. For example, a configuration is also possible which makes the decision according to the strength (electric field intensity) of the digital broadcasting signal the tuner section 22 receives directly. Alternatively, a configuration is also possible which makes the decision according to the processing error incidence rate in the MPEG demultiplexing processing or MPEG decoding processing in the decoder section 23.

### INDUSTRIAL APPLICABILITY

As described above, the broadcast receiving apparatus in accordance with the present invention is suitable for the apparatus that has an added function, and provides a user with the added function after making the validity decision about the expansion service to be provided to the user as the added function.

What is claimed is:

1. A broadcast receiving apparatus comprising:
a broadcast receiving section for receiving a broadcast through a channel designated by channel control information;
an expansion service providing section for providing an expansion service as an added function to a broadcast receiving function;
an expansion service decision section for making a decision as to whether the expansion service provided by said expansion service providing section is valid or not;
a channel alteration section for adding, when said expansion service decision section makes a decision that the expansion service is valid, the expansion service provided by said expansion service providing section as one channel;
an input section for inputting operation information for selecting one channel from channels receivable by said broadcast receiving section and a channel added by said channel alteration section;
a channel control section for starting, when the channel selected according to the operation information input from said input section is a channel receivable by said broadcast receiving section, reception of the broadcast by delivering the channel control information designating the channel to said broadcast receiving section, and for generating output switching information for switching between an output of said broadcast receiving section and an output of said expansion service providing section to select the output to be used; and
an output section for outputting information based on the output of said broadcast receiving section or the output of said expansion service providing section switched in response to the output switching information from said channel control section.

2. The broadcast receiving apparatus according to claim 1, wherein
said channel alteration section deletes, when a decision result by said expansion service decision section changes from a valid to invalid state, the channel corresponding to the expansion service that changes to the invalid state.

3. The broadcast receiving apparatus according to claim 1, wherein
said expansion service decision section makes a decision as to whether the expansion service is valid or not according the presence or absence of data used for the expansion service provided by said expansion service providing section.

4. The broadcast receiving apparatus according to claim 1, further comprising:
an external apparatus condition detecting section for detecting a condition of an external apparatus, wherein
said expansion service decision section makes a decision as to whether the expansion service is valid or not according to the condition of said external apparatus detected by said external apparatus condition detecting section.

5. The broadcast receiving apparatus according to claim 1, further comprising:
an information storing section for storing in advance information indicating whether the expansion service is valid or not, wherein
said expansion service decision section makes a decision as to whether the expansion service is valid or not according to the information obtained from said information storing section.

6. The broadcast receiving apparatus according to claim 5, further comprising:
an information alteration section for altering information stored in said information storing section.

7. The broadcast receiving apparatus according to claim 1, further comprising:
a mobile unit condition acquiring section for acquiring a condition of a mobile unit on which said broadcast receiving apparatus is mounted, wherein
said expansion service decision section makes a decision as to whether the expansion service is valid or not according to the condition of the mobile unit acquired by said mobile unit condition acquiring section.

8. The broadcast receiving apparatus according to claim 1, further comprising:
a mobile unit condition acquiring section for acquiring a condition of a mobile unit on which said broadcast receiving apparatus is mounted, wherein
said channel control section switches, according to the condition of the mobile unit acquired by said mobile unit condition acquiring section, to a preselected channel from among the channels added by said channel alteration section.

9. The broadcast receiving apparatus according to claim 8, wherein
said channel control section selects one of the channels added by said channel alteration section in accordance with the operation information input from said input section, and switches to the selected channel in accordance with the condition of the mobile unit acquired by said mobile unit condition acquiring section.

10. The broadcast receiving apparatus according to claim 1, further comprising:
a mobile unit condition acquiring section for acquiring a condition of a mobile unit on which said broadcast receiving apparatus is mounted, wherein
said channel control section alters, according to the condition of the mobile unit acquired by said mobile unit condition acquiring section, a type of information to be output from said output section.

11. The broadcast receiving apparatus according to claim 1, wherein
said channel control section comprises a channel sequence alteration section for altering a sequence of channels to be switched, and switches the channels according to the sequence of the channels altered by said channel sequence alteration section.

12. The broadcast receiving apparatus according to claim 11, wherein
said channel sequence alteration section alters the sequence of the channels in accordance with the operation information input from said input section.

13. The broadcast receiving apparatus according to claim 11, wherein
said channel sequence alteration section measures a selection frequency of the channel selected in accordance with the operation information input from said input section, and alters the sequence of the channels in accordance with the selection frequency of the channel measured.

14. The broadcast receiving apparatus according to claim 1, wherein
said channel control section stores recognition target information associated with a channel, and generates, when a result of performing recognition processing on the operation information input from said input section agrees with the recognition target information, the output switching information for switching between the output of said broadcast receiving section and the output of said expansion service providing section to select one of the outputs, which corresponds to the channel associated with the recognition target information.

15. The broadcast receiving apparatus according to claim 14, wherein
the recognition target information to be stored in said channel control section is transmitted from said expansion service providing section to be set.

16. The broadcast receiving apparatus according to claim 14, wherein
the recognition target information to be stored in said channel control section is set in accordance with the operation information input from said input section.

17. The broadcast receiving apparatus according to claim 14, further comprising:
a mobile unit condition acquiring section for acquiring a condition of a mobile unit on which said broadcast receiving apparatus is mounted, wherein
said channel control section stores a plurality of recognition target information items associated with the channels, and generates, when a result of performing recognition processing on the operation information input from said input section agrees with one recognition target information item selected from the plurality of recognition target information items in accordance with the condition of the mobile unit acquired by said mobile unit condition acquiring section, the output switching information for switching between the output of said broadcast receiving section and the output of said expansion service providing section to select one of the outputs, which corresponds to the channel associated with the recognition target information item.

18. The broadcast receiving apparatus according to claim 1, wherein
said broadcast receiving section comprises a reception detecting section for detecting reception conditions of a broadcast; and
said channel control section generates output switching information for performing, in accordance with the reception conditions received from said reception detecting section, switching in a manner that the expansion service providing section corresponding to a preset channel is used.

19. The broadcast receiving apparatus according to claim 18, wherein
said channel control section alters a channel of a preset expansion service in accordance with the operation information input from said input section.

20. The broadcast receiving apparatus according to claim 18, comprising:
a plurality of expansion service providing sections, wherein
each of said expansion service providing sections delivers, to said channel control section, channel control enabled/disabled information indicating switching appropriateness; and
said channel control section generates the output switching information for switching in a manner as to use one expansion service providing section selected from the expansion service providing sections that are designated as switchable by the channel control enabled/disabled information received.

21. The broadcast receiving apparatus according to claim 20, comprising:
a plurality of expansion service providing sections, wherein
each of said expansion service providing sections delivers, to said channel control section, the channel control enabled/disabled information and priority information; and
said channel control section generates the output switching information for switching in a manner as to use the expansion service providing section selected in accordance with a degree of priority designated by the priority information received.

22. The broadcast receiving apparatus according to claim 1, wherein
said expansion service providing section offers at least one of electronic map display service, car navigation service, WEB browser service, facility information providing service, electronic mail service, camera video display service, recorded video playback service, program guide providing service, data broadcasting providing service, traffic information providing service, music playback service and still picture display service.
